(19) United States
(12) Patent Application Publication
(10) Pub. No.: US 2023/0143451 A1
(43) Pub. Date: May 11, 2023

(54) Method and Apparatus of Image Adjustment for Gastrointestinal Tract Images

(71) Applicant: CAPSOVISION, Inc., Saratoga, CA (US)

(72) Inventors: Chenyu Wu, Sunnyvale, CA (US); Kang-Huai Wang, Saratoga, CA (US)

(21) Appl. No.: 17/519,869

(22) Filed: Nov. 5, 2021

(51) Int. Cl. G06T 5/00; G06T 7/00

(52) U.S. Cl. CPC G06T 5/00; G06T 7/0012; G06T 2207/10068; G06T 2207/30028

(57) ABSTRACT

A method of processing gastrointestinal images is disclosed. According to embodiments of the present invention, a plurality of images from an endoscope, wherein the plurality of images is captured by the endoscope when the endoscope travels through a GI (gastrointestinal) tract are received. Corresponding anatomical parts associated with the plurality of images are then determined. A selected image process is applied to a target image from the plurality of images, where one or more parameters of the selected image process are determined according to a corresponding anatomical part determined for the target image.

### FIELD OF THE INVENTION

The present invention is related to processing of images captured by an endoscope when the endoscope travelled through the gastrointestinal (GI) tract. In particular, the present invention is related to image processing to enhance the images for improved diagnosis.

### BACKGROUND AND RELATED ART

Devices for imaging body cavities or passages in vivo are known in the art and include endoscopes and autonomous encapsulated cameras. Endoscopes are flexible or rigid tubes that pass into the body through an orifice or surgical opening, typically into the esophagus via the mouth or into the colon via the rectum. An image is formed at the distal end using a lens and transmitted to the proximal end, outside the body, either by a lens-relay system or by a coherent fiber-optic bundle. A conceptually similar instrument might record an image electronically at the distal end, for example using a CCD or CMOS array, and transfer the image data as an electrical signal to the proximal end through a cable. Endoscopes allow a physician control over the field of view and are well-accepted diagnostic tools. However, they do have a number of limitations, present risks to the patient, are invasive and uncomfortable for the patient, and their cost restricts their application as routine health-screening tools.

Because of the difficulty traversing a convoluted passage, endoscopes cannot easily reach the majority of the small intestine and special techniques and precautions, that add cost, are required to reach the entirety of the colon. Endoscopic risks include the possible perforation of the bodily organs traversed and complications arising from anesthesia. Moreover, a trade-off must be made between patient pain during the procedure and the health risks and post-procedural down time associated with anesthesia.

An alternative in vivo image sensor that addresses many of these problems is the capsule endoscope. A camera is housed in a swallowable capsule, along with a radio transmitter for transmitting data, primarily comprising images recorded by the digital camera, to a base-station receiver or transceiver and data recorder outside the body. The capsule may also include a radio receiver for receiving instructions or other data from a base-station transmitter. Instead of radio-frequency transmission, lower-frequency electromagnetic signals may be used. Power may be supplied inductively from an external inductor to an internal inductor within the capsule or from a battery within the capsule.

Imaging in the GI tract presents a challenging task due to the hostile imaging environment in the GI tract. For example, the camera has to travel through the very narrow passage in the GI tract and the object (e.g., the GI wall) may be in very short distance or may be even contacting the camera. There is no ambient light in the GI tract, and therefore the illumination has to be dependent on the light source (e.g., LED light) from the endoscope. The reflection from the GI tract wall often cause over-exposure in the image. On the other hand, the image area corresponding to folds of the GI tract may look very dark since the area may not receive enough light from the endoscope. Moreover, richness in certain colon components in the GI tracts in vivo setting make color accuracy a challenge.

Accordingly, it is desirable to enhance images to improve accuracy of diagnosis based on the images. Sometimes, an area in the image may be over-exposed and another area of the image may be under-exposed. Any processing to the images should be selectively applied to avoid any inadvertent result.

### BRIEF SUMMARY OF THE INVENTION

A method of processing gastrointestinal images has been disclosed. According to embodiments of the present invention, a plurality of images from a GI (gastrointestinal) tract are received. Corresponding anatomical parts associated with the plurality of images are then determined. A selected image process is applied to a target image from the plurality of images, where one or more parameters of the selected image process are determined according to a corresponding anatomical part determined for the target image.

In one embodiment, the corresponding anatomical parts comprise two or more parts selected from a group comprising a small intestine and a colon.

In one embodiment, the selected image process corresponds to a color correction process or a color enhancement process. In one embodiment, the color correction process or the color enhancement process is applied to the target image in a color space selected from a color space group comprising RGB, YUV and HSV (hue, saturation, value). In one embodiment, the color correction process or the color enhancement process accentuates redness only if the target image is from a colon. In one embodiment, the color correction process or the color enhancement process accentuates redness more for the target image from a colon than the target image from a small intestine.

In one embodiment, the color correction process or the color enhancement process is implemented in a form of matrix multiplication, wherein a color corrected or enhanced output pixel is generated by multiplying an input pixel with a matrix and then adding an offset. In another embodiment, each color component of a color corrected or enhanced output pixel is generated by modifying a corresponding color component of an input pixel.

A non-transitory computer-readable medium has also been disclosed, where the non-transitory computer-readable medium has stored thereon a computer-readable code executable by a processor to cause the processor to perform the above method.

### BRIEF DESCRIPTION OF THE DRAWINGS

FIG. 1 illustrates an exemplary flowchart for processing gastrointestinal images according to an embodiment of the present invention, where one or more parameters of a selected image process is applied to a target image according to a corresponding anatomical part determined for the target image.

### DETAILED DESCRIPTION OF THE INVENTION

It will be readily understood that the components of the present invention, as generally described and illustrated in the figure herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawing, wherein like parts are designated by like numerals throughout. The following description is intended only by way of example, and simply illustrates certain selected embodiments of apparatus and methods that are consistent with the invention as claimed herein.

Endoscopes are normally inserted into the human body through a natural opening such as the mouth or anus. Therefore, endoscopes are preferred to be small sizes so as to be minimally invasive. As mentioned before, endoscopes can be used for diagnosis of human gastrointestinal (GI) tract. The captured image sequence can be viewed to identify any possible anomaly. If any anomaly is found, it is of interest to identify the characteristics of the anomaly as well as its location. Beside diagnosis by a human professional, automated endoscopic disease activity assessment based on artificial intelligence has gained popularity in recent years. In particular, advances in machine learning methods have greatly improved the performance of artificial intelligence (AI). The accuracy of AI based diagnosis often can outperform human based diagnosis. Gastroenterology has been a field to see rapid adoption of AI methods for automated assessment of various GI conditions and diseases. For example, the AI based methods can replicate expert endoscopic interpretation, polyp recognition in the colon. This situation applies to tethered endoscopes and capsule endoscopes as well.

Assessment of GI conditions and diseases using images captured by an endoscope relies heavily on the picture quality of the images regardless by a human expert or an AI method. In some cases, the color of an image may reveal important diagnostic information. For example, a doctor may look for bright red color as an indication of possible bleeding in the GI wall. This situation applies to tethered endoscopes and capsule endoscopes as well.

For conventional image processing, a selected image processing technique is often applied to images that are presumably subject to certain artifacts or some impairments such as under- or over-exposure, improper color balance, or blurry. Even if the image quality may appear to be normal, sometimes, it may be desirable to apply different image processing techniques to images from different anatomic GI parts (e.g., small intestine and colons). For example, it may be desirable to accentuate the redness of the colons so the pathologies (e.g., bleeding or polyps) may look more prominent for doctors to see easily. However, the small bowel already has much more redness and we would not want to accentuate the redness further to avoid saturation.

Accordingly, embodiments of the present invention select a target image processing method or select image processing parameters depending on the anatomic part associated with the underlying images. In one embodiment, the image process may correspond to a color correction process or a color enhancement process. The color correction process or the color enhancement process by itself is well known in the image processing field. Various color correction or enhancement algorithms have been disclosed. Usually, a suitable color space is used to represent pixels of a color image. The RGB (red, green and blue) has been a very popular color space being used for image sensor. The RGB corresponds to three primary colors that can be mixed to reproduce various colors. The YUV color space is another popular color space being used, where Y corresponds to the luminance signal while U and V represent chrominance signals. On the other hand, CIELAB is another popular color space that is designed to approximate human vision. The CIELAB color space is also referred as L*a*b* model since it uses L*a*b* color coordinates representing the lightness of the color (L*), its position between red and green (a*) and its position between yellow and blue (b*). The L* component closely matches human perception of lightness, where L*=0 yields black and L*=100 indicates diffuse white. In addition, HSV (hue, saturation, value) is yet another popular color space. The present invention is not limited to any particular color space.

The parameters for color correction can be designed using reference patterns with known colors. For example, color chart with known color components can be used as ground truth. The captured color pixels can be compared with the colors of the ground truth to derive the color correction matrix or nonlinear function. In this case, the corrected color pixel can be derived by multiplying a captured color pixel by a color correction matrix or applying the nonlinear function. An offset value can be added to the multiplication result. Color enhancement can also be performed in a similar fashion using matrix multiplication. However, color enhancement can also be done by simply modifying individual color component such as boosting the red component in case that the RGB format is used.

The images associated with different anatomical parts may have different characteristics. A selected image process may help improve image quality or help ease diagnosis by viewing the processed images associated with one particular anatomical part. However, the selected image process or the particular parameters of the selected image process may not be proper for images from other anatomical part. For example, by boosting the red color may help visually spot anomaly in the colon. However, boosting the red color may cause color saturation since the images from the small intestine often look more reddish than the images from the colon. Accordingly, we may like to accentuate the redness for images from the colon only and we do not accentuate the redness for images from other anatomic parts. In another example, we can accentuate the redness for images from the colon more than other anatomic parts. The same method can be applied to all anatomical parts of GI tracts, such as esophagus, stomach, small bowel and colon, and the associated sub-parts. For a capsule endoscope, in one embodiment, the parameters for esophagus can be applied in the beginning knowing that it is at the beginning of the GI tract after the mouth. For a capsule endoscope, in another embodiment, the parameters for the stomach can be applied after a certain time, for example, knowing at that time the capsule is in the stomach.

The images from the GI tract can be divided into groups according to their associated anatomic parts such as small bowel and colons. The segmentation can be done manually by scanning through the image sequence by a medical professional to spot particular noticeable features for transition from one anatomic part to another. The segmentation can also be done using an automated process to identify or detect certain characteristics of the images associated with the anatomic parts. Upon segmentation of the GI anatomic parts, image processing can be selectively applied a selected GI anatomic part. Location determining devices such as a gyroscope, accelerometer, or electronic compass may be embedded or attached to the capsule device to record the capsule locations in the GI tract.

The method mentioned above can be implemented using various programmable devices such as micro-controller, central processing unit (CPU), field programmable gate array (FPGA), digital signal processor (DSP) or any programmable processor with or without firmware or software. A display can be used for presenting the visual information related to travelled distance and/or image information. Furthermore, mobile devices such as tablets or smart phones can be used to implement the method mentioned above since the mobile devices usually have a display and sufficient computational capability to handle the needed processing mentioned above. A notebook or a computer can also serve as the system to support the method mention above.

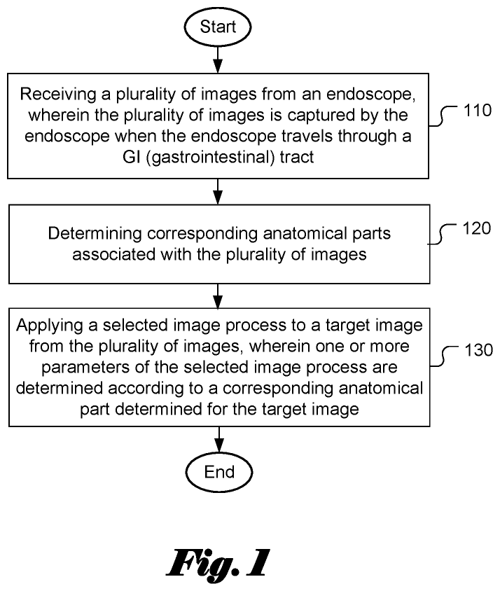

FIG. 1 illustrates an exemplary flowchart for processing gastrointestinal images according to an embodiment of the present invention. According to this method, a plurality of images from an endoscope, wherein the plurality of images is captured by the endoscope when the endoscope travels through a GI (gastrointestinal) tract are received in step 110. Corresponding anatomical parts associated with the plurality of images are determined in step 120. A selected image process is applied to a target image from the plurality of images in step 130, wherein one or more parameters of the selected image process are determined according to a corresponding anatomical part determined for the target image.

The above description is presented to enable a person of ordinary skill in the art to practice the present invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of processing gastrointestinal images, the method comprising:
receiving a plurality of images from an endoscope, wherein the plurality of images is captured by the endoscope when the endoscope travels through a GI (gastrointestinal) tract;
determining corresponding anatomical parts associated with the plurality of images; and
applying a selected image process to a target image from the plurality of images, wherein one or more parameters of the selected image process are determined according to a corresponding anatomical part determined for the target image.

2. The method of claim 1, wherein the corresponding anatomical parts comprise two or more parts selected from a group comprising a small intestine and a colon.

3. The method of claim 1, wherein the selected image process corresponds to a color correction process or a color enhancement process.

4. The method of claim 3, wherein the color correction process or the color enhancement process is applied to the target image in a color space selected from a color space group comprising RGB, YUV, HSV (hue, saturation, value) and CIELAB.

5. The method of claim 3, wherein the color correction process or the color enhancement process accentuates redness only if the target image is from a colon.

6. The method of claim 3, wherein the color correction process or the color enhancement process accentuates redness more for the target image from a colon than the target image from a small intestine.

7. The method of claim 3, wherein the color correction process or the color enhancement process is implemented in a form of matrix multiplication or a nonlinear function, wherein a color corrected or enhanced output pixel is generated by multiplying an input pixel with a matrix and then adding an offset or applying the nonlinear function.

8. The method of claim 3, wherein each color component of a color corrected or enhanced output pixel is generated by modifying a corresponding color component of an input pixel.

9. The method of claim 1, wherein if a set of images are captured when the endoscope enters a new anatomical part, one or more new parameters of the selected image process are used for the set of images.

10. The method of claim 1, wherein the endoscope corresponds to a tethered endoscope or a capsule endoscope.

11. A non-transitory computer-readable medium having stored thereon a computer-readable code executable by a processor to cause the processor to:
receive a plurality of images from a GI (gastrointestinal) tract;
determine corresponding anatomical parts associated with the plurality of images; and
apply a selected image process to a target image from the plurality of images, wherein one or more parameters of the selected image process are determined according to a corresponding anatomical part determined for the target image.
